(19) United States
(12) Patent Application Publication
(10) Pub. No.: US 2015/0067407 A1
(43) Pub. Date: Mar. 5, 2015

(54) ELECTRONIC DEVICE AND METHOD FOR TESTING STORAGE SYSTEM

(71) Applicant: HON HAI PRECISION INDUSTRY CO., LTD., New Taipei (TW)

(72) Inventor: SZU-LUN HUANG, New Taipei (TW)

(73) Assignee: HON HAI PRECISION INDUSTRY CO., LTD., New Taipei (TW)

(21) Appl. No.: 14/133,722

(22) Filed: Dec. 19, 2013

(30) Foreign Application Priority Data
Aug. 29, 2013 (TW) 102131140

(51) Int. Cl. G06F 11/263

(52) U.S. Cl. CPC G06F 11/2635
USPC 714/42

(57) ABSTRACT

In a method for testing a storage system, each disk of a storage system is numbered, and a disk of a number is selected as a root node of a binary tree. A probability that the nodes of each level of the binary tree is completely added into the binary tree is computed according to a predefined algorithm, and the nodes of each level of the binary tree are added into the binary tree according to the computed probability. And each disk is tested when the disk is added into the binary tree as the node of the binary tree.

### BACKGROUND

1. Technical Field

The embodiments of the present disclosure relate to an electronic device and a method for testing a storage system.

2. Description of Related Art

Before servers are shipped to customers, storage systems of the servers need to be tested. Usually, a storage system of a server having a storage capacity of 16GB may take twenty-five minutes to be tested. If a factory produces thousands of the servers, testing of such thousands of servers will take a lot of time.

### BRIEF DESCRIPTION OF THE DRAWINGS

FIG. 1 is a block diagram of one embodiment of an electronic device including a storage test system.

FIG. 2 is a block diagram of one embodiment of function modules of the storage test system in FIG. 1.

FIG. 3 is a flowchart of one embodiment of a method for testing a storage system.

FIG. 4 is a diagram of one embodiment of adding each disk of the storage system into a binary tree.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

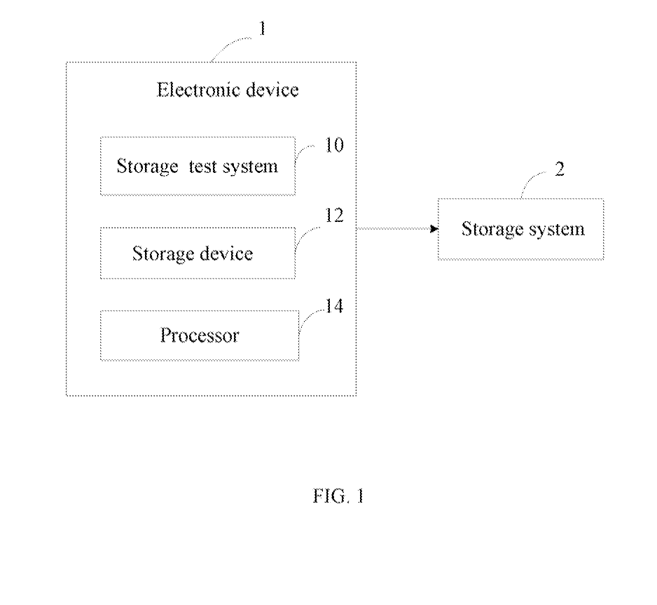

FIG. 1 is a block diagram of one embodiment of an electronic device 1 including a storage test system 10, a storage device 12, at least one processor 14. The electronic device 1 may be a desk computer, a notebook, a server, or other computer device. The storage device testing system 10 is used to automatically test a storage system 2 connected to the electronic device 1.

In one embodiment, the storage device 12 (a non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

In one embodiment, the storage test system 10 includes a plurality of function modules which include computerized codes or instructions that can be stored in the storage device 12 and executed by the at least one processor 14 to provide a method for testing a storage system.

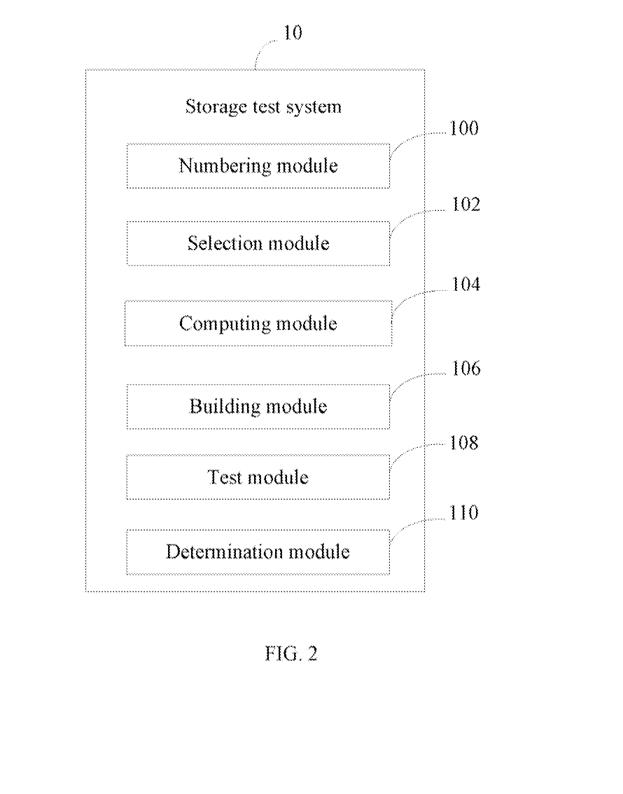

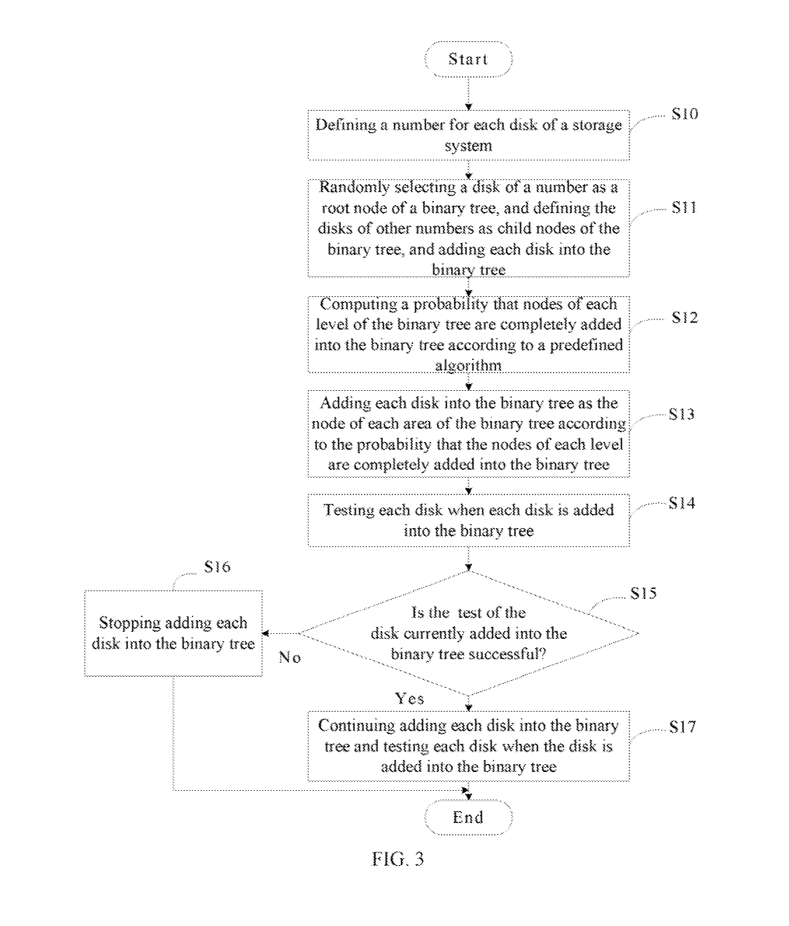

FIG. 2 is a block diagram of one embodiment of function modules of the storage test system 10 in FIG. 1. In the embodiment, the storage test system 10 includes a numbering module 100, a selection module 102, a computing module 104, a building module 106, a test module 108, and a determination module 110. The modules may comprise computerized codes in the form of one or more programs that are stored in the storage device 12 and executed by the at least one processor 14 to provide functions for implementing the storage test system 10. The functions of the function modules are illustrated in FIG. 3 and described below.

FIG. 3 is a flowchart illustrating one embodiment of a method for testing the storage system 2. Depending on the embodiment, additional steps may be added, others removed, and the ordering of the steps may be changed.

In step S10, the numbering module 100 numbers each disk of the storage system 2 in an order of memory addresses of the disks. In the embodiment, the storage system 2 includes a plurality of disks for storing computerized data.

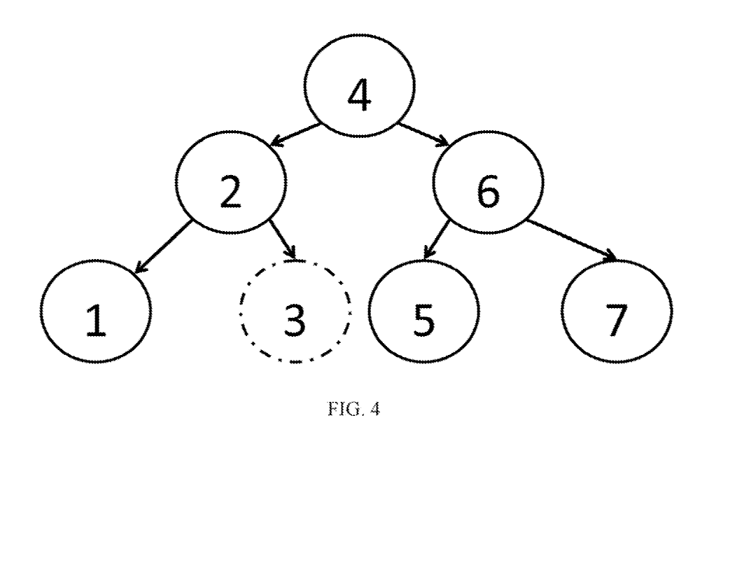

In step S11, the selection module 102 randomly selects a disk of a number as a root node of a binary tree, defines the disks of the other numbers as child nodes of the binary tree, and adds each disk into the binary tree as the node of the binary tree according to the order of the numbers of the disks. As shown in FIG. 4, the disk of number 4 is defined as the root node of the binary tree. The disk of number 2 and the disk of number 6 are child nodes of the disk of number 4, and the disk of number 5 and 7 are child nodes of the disk of number 6.

In step S12, a computing module 104 computes a probability that nodes of each layer of the binary tree are completely added into the binary tree according to a predefined algorithm, where the predefined algorithm is used to reduce the probability of completely adding the nodes of each layer into the binary tree when a depth of the binary tree grows. In the embodiment, the predefined algorithm may be predefined as: the probability of completely adding the nodes of each level of the binary tree into the binary tree=1−0.04* a current depth of the binary tree. For example, the probability that the nodes of the first level of the binary tree are completely added into the binary tree=1−0.04*0=100%, the probability that the nodes of the second level of the binary tree are completely added into the binary tree=1−0.04*1=96%, and the probability that the nodes of the third level of the binary tree are completely added into the binary tree=1−0.04*2=92%.

In step S13, the building module 106 adds each disk into the binary tree as the node of each level of the binary tree according to the probability that the nodes of each level are completely added into the binary tree. For example, the probability that the nodes of the first level of the binary tree are completely added into the binary tree is 100%, the disk of number 4 is added into the first level of the binary tree. The probability that the nodes of the second level of the binary tree are completely added into the binary tree is 96%, the disk of number 2 and 6 are added into the second level of the binary tree. The probability that the nodes of the third level of the binary tree are completely added into the binary tree is 92%, the disk of number 5 and 6 are added into the third level of the binary tree, but the disk of number 1 and 3 in the third level are not built into the binary tree. In the above example, it is assumed that the probability of completely adding the second level of the binary tree is greater than that of the third level of the binary tree, and the nodes of the third level of the binary tree are not completely added into the binary tree.

In step S14, the test module 108 tests each disk when the disk is added into the binary tree. In the embodiment, each disk is tested by a traditional way manufacturers usually test their manufactured disk for compliance with requirements of customers. In the embodiment, a speed, temperature, or any other parameters of each disk are tested.

In step S15, the determination module 110 determines if the test of the disk currently added into the binary tree is successful.

In step S16, the test module 108 stops adding each disk into the binary tree if the test of the disk currently built into the binary tree is unsuccessful.

In step S17, the test module 108 continues adding each disk into the binary tree as the node of the binary tree, and tests each disk added into the binary tree when the disk is added into the binary tree, if the test of the each disk added into the binary tree is successful.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
at least one processor; and
a storage device storing a computer program including instructions that, which executed by the at least one processor, causes the at least one processor to:
define a number for each disk of a storage system;
randomly select a disk of a number as a root node of a binary tree, and define the disks of other numbers as child nodes of the binary tree, and add each disk into the binary tree as the node of the binary tree according to an order of the numbers of the disks;
compute a probability that nodes of each layer of the binary tree is completely added into the binary tree according to a predefined algorithm, wherein the predefined algorithm makes the probability of completely adding the nodes of each layer into the binary tree reduced when a depth of the binary tree grows;
add each disk into the binary tree as the node of each level of the binary tree according to the probability of completely adding the nodes of the level into the binary tree; and
test each disk when the disk is added into the binary tree.

2. The electronic device as claimed in claim 1, wherein the computer program including instructions further causes the at least one processor to:
determine whether the test of the disk currently added into the binary tree is successful;
stop adding each disk into the binary tree if the test of the disk currently added into the binary tree is unsuccessful;
continue adding each disk into the binary tree and test the each disk added into the binary tree if the test of the disk currently built into the binary tree is successful.

3. The electronic device as claimed in claim 1, wherein the predefined algorithm is defined as:
the probability of completely adding the nodes of each level into the binary tree=1−0.04* a current depth of the binary tree.

4. A method executable by a processor of an electronic device for testing a qualification of a storage system using an electronic device, the storage system comprising a plurality of disks, the method comprising:
defining a number for each disk of a storage system;
randomly selecting a disk of a number as a root node of a binary tree, and defining the disks of other numbers as child nodes of the binary tree, and adding each disk into the binary tree as the node of the binary tree according to an order of the numbers of the disks;
computing a probability that nodes of each layer of the binary tree is completely added into the binary tree according to a predefined algorithm, wherein the predefined algorithm makes the probability of completely adding the nodes of each layer into the binary tree is reduced when a depth of the binary tree grows;
adding each disk into the binary tree as the node of each level of the binary tree according to the probability of completely adding the nodes of the level into the binary tree; and
testing each disk when the disk is added into the binary tree.

5. The method as claimed in claim 4, further comprising:
determining whether the test of the disk currently added into the binary tree is successful;
stopping adding each disk into the binary tree if the test of the disk currently added into the binary tree is unsuccessful;
continuing adding each disk into the binary tree and test the each disk added into the binary tree if the test of the disk currently built into the binary tree is successful.

6. The method as claimed in claim 4, wherein the predefined algorithm is defined as: the probability of completely adding the nodes of each level into the binary tree=1−0.04* a current depth of the binary tree.

7. A non-transitory computer-readable storage medium having stored thereon instructions being executed by a processor of an electronic device, causes the processor to perform a method for testing a qualification of a storage system, the storage system comprising a plurality of disks, the method comprising:
defining a number for each disk of a storage system;
randomly selecting a disk of a number as a root node of a binary tree, and defining the disks of other numbers as child nodes of the binary tree, and adding each disk into the binary tree as the node of the binary tree according to an order of the numbers of the disks;
computing a probability that nodes of each layer of the binary tree is completely added into the binary tree according to a predefined algorithm, wherein the predefined algorithm makes the probability of completely adding the nodes of each layer into the binary tree is reduced when a depth of the binary tree grows;
adding each disk into the binary tree as the node of each level of the binary tree according to the probability of completely adding the nodes of the level into the binary tree; and
testing each disk when the disk is added into the binary tree.

8. The storage medium as claimed in claim 7, wherein the method further comprising:
determining whether the test of the disk currently added into the binary tree is successful;
stopping adding each disk into the binary tree if the test of the disk currently added into the binary tree is unsuccessful;
continuing adding each disk into the binary tree and test the each disk added into the binary tree if the test of the disk currently built into the binary tree is successful.

9. The storage medium as claimed in claim 7, wherein the predefined algorithm is defined as:
the probability of completely adding the nodes of each level into the binary tree=1−0.04* a current depth of the binary tree.
